(19) United States
(12) Patent Application Publication
(10) Pub. No.: US 2009/0056107 A1
(43) Pub. Date: Mar. 5, 2009

(54) Electrically heated articles of apparel and methods of making same

(76) Inventor: Cole Williams, Bainbridge Island, WA (US)

Correspondence Address: JAMES E. BRUNTON, ESQ., P. O. BOX 29000, GLENDALE, CA, 91209, US

(21) Appl. No.: 11/899,428

(22) Filed: Sep. 5, 2007

(51) Int. Cl. H05B 3/00; H01S 4/00

(52) U.S. Cl. 29/610.1; 29/592.1; 29/611

(57) ABSTRACT

An electrically heated, multi-layered article of apparel that is heated by a novel, silver-coated, flexible, battery-powered heating harness that is disposed between the layers of the article.

### BACKGROUND OF THE INVENTION

1. Field of the Invention

The present invention relates generally to electrically heated articles of apparel and methods of making the same. More particularly, the invention concerns an electrically heated diving glove and the method of making the glove.

2. Discussion of the Prior Art

Various types of heated garments, including heated gloves have been suggested in the past. Batteries are typically used in these prior art garments to provide the source of electrical power to heat various types of heating elements, such as fine wires, that are embedded in the material from which the garment is fabricated. During use of the garment the heating elements are frequently subjected to undue stress that causes degradation and ultimate failure. Moreover, due to their bulk and lack of flexibility, the prior art garments are often cumbersome and uncomfortable in use. Additionally, because the length of the heating elements that, due to electrical resistance, heat the prior art garments, typically vary in length and, therefore, vary in resistance, the prior art garments are generally heated unevenly.

Accordingly, it is an object of the present invention to provide an electrically heated article of apparel that is uniformly heated by a novel, yieldably deformable heater harness that comprises a plurality of thin interconnected, electrically conductive tape-like members that are constructed from selected stretchable fibers and are of substantially equal length.

### SUMMARY OF THE INVENTION

It is an object of the present invention to provide an electrically heated, multi-layered article of apparel that is heated by a novel, silver-coated, flexible heating harness that is disposed between the layers of the article. More particularly, it is an object of the invention to provide an article of apparel of the aforementioned character that comprises a controllably heated glove that can be used for diving.

Another object of the invention is to provide an electrically heated diving glove as described in the preceding paragraph in which the thin silver-coated, flexible heating harness is coated with an electrical, waterproof insulation.

Another object of the invention is to provide an electrically heated diving glove as described in the preceding paragraphs in which the flexible heating harness can effectively withstand the stresses caused by movement of the diver's hand.

Another object of the invention is to provide an electrically heated article of apparel as described in the preceding paragraphs that exhibits substantially uniform stretch-and-return characteristics.

Another object of the invention is to provide an electrically heated article of apparel of the class described in which the flexible heating harness comprises a plurality of thin interconnected, electrically conductive tape-like members that are of substantially equal length.

Another object of the invention is to provide an article of apparel of the character described that includes a controller assembly that is operably associated with the heating harness for controlling the temperature thereof.

Another object of the invention is to provide an electrically heated article of apparel as described in the preceding paragraphs that is easy to don, comfortable to wear and uniformly heats the portion of the user's body that is covered by the article of apparel.

Another object of the invention is to provide an electrically heated article of apparel of the class described that has the general shape of a human hand.

Another object of the present invention is to provide an electrically heated article of apparel of the class described that has the general shape of a human foot.

Another object of the invention is to provide an article of apparel as described in the preceding paragraphs that is attractive in appearance and highly reliable in use.

It is another object of the invention to provide an electrically heated article of apparel, such as a glove or sock that is simple and economical to use and manufacture.

The forgoing as well as other objects of the invention will be realized by the inventions described more fully in the paragraphs that follow.

### BRIEF DESCRIPTION OF THE DRAWINGS

FIG. 1 is a generally perspective view of one form of the electrically heated diving glove of the invention.

FIG. 2 is a greatly enlarged, generally perspective view of the area designated in FIG. 1 as 2-2.

FIG. 3 is a top plan view, partly broken away to show internal construction of the electrically heated glove of the invention in position over a rigid, generally hand-shaped mandrel.

FIG. 4 is an enlarged, cross-sectional view taken along lines 4-4 of FIG. 3.

FIG. 5 is a top plan view illustrating the construction of one form of the heater harness component of the invention.

FIG. 6 is a top plan view showing the heating harness affixed to the inner-liner component of the electrically heated glove of the invention and showing the assemblage in position over the rigid, generally hand-shaped mandrel.

FIG. 7 is a bottom plan view of the assemblage shown in FIG. 6.

FIG. 8 is a generally perspective view of one form of the electrically heated sock of the invention.

FIG. 9 is a greatly enlarged, generally perspective view of the area designated in FIG. 8 as 9-9.

FIG. 10 is a top plan view, partly broken away to show internal construction of the electrically heated sock of the invention in position over a rigid, generally foot mandrel.

FIG. 11 is an enlarged, cross-sectional view taken along lines 11-11 of FIG. 8.

FIG. 12 is an enlarged, cross-sectional view taken along lines 12-12 of FIG. 10.

FIG. 13 is a top plan view illustrating the construction of an alternate form of the heater harness component of the invention.

FIG. 14 is a top plan view of one side of the inner-liner mandrel assemblage showing the heating harness affixed to the inner-liner component of the electrically heated sock of the invention.

FIG. 15 is a top plan view of the opposite side of the inner-liner mandrel assemblage showing the heating harness affixed to the inner-liner component of the electrically heated sock of the invention.

FIG. 16 is a side-elevational view of one form of the platen press assembly used in carrying out one form of the method of the invention.

### DESCRIPTION OF THE INVENTION

As used herein, the following terms have the following meanings:

The term “fabric” as used herein means a material of any kind that is woven, spun, braided or knit from fibers, either vegetable or animal or man made.

The term “mandrel” as used herein means a rigid, generally planar, relatively thin support member having the general shape of an article of apparel.

The term “spandex” as used herein means a long-chain synthetic polymeric fiber. Soft and rubbery segments of polyester or polyether polyols allow the fiber to stretch up to 600% and then recover to its original shape.

The term “silver-plating” as used herein means a process for plating metallic silver onto an object, such as a process commonly known as ‘electroless plating.’

The term “snap fastener” as used herein means a closure device made of electrically conductive metal consisting of a closure unit and attaching unit, which when interconnected, complete an electrical circuit.

The term “battery” as used herein means a device that stores chemical energy and makes it available in an electrical form.

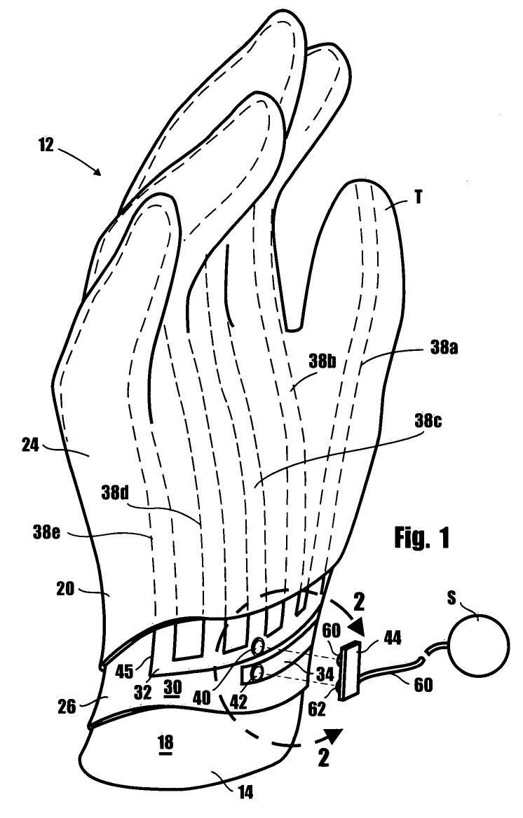

Referring now to the drawings and particularly to FIGS. 1 through 4, one form of the electrically heated article of apparel of the present invention, here shown as a glove is there illustrated and generally designated by the numeral 12. As best seen in FIGS. 1, 3 and 4, the electrically heated glove 12 comprises a three-ply construction that includes a user contact, or inner glove portion, 14 having inner and outer surfaces 16 and 18 and an outer glove portion 20 having inner and outer surfaces 22 and 24. Disposed intermediate portions 14 and 20 is a liner glove portion 26 having inner and outer surfaces 28 and 29.

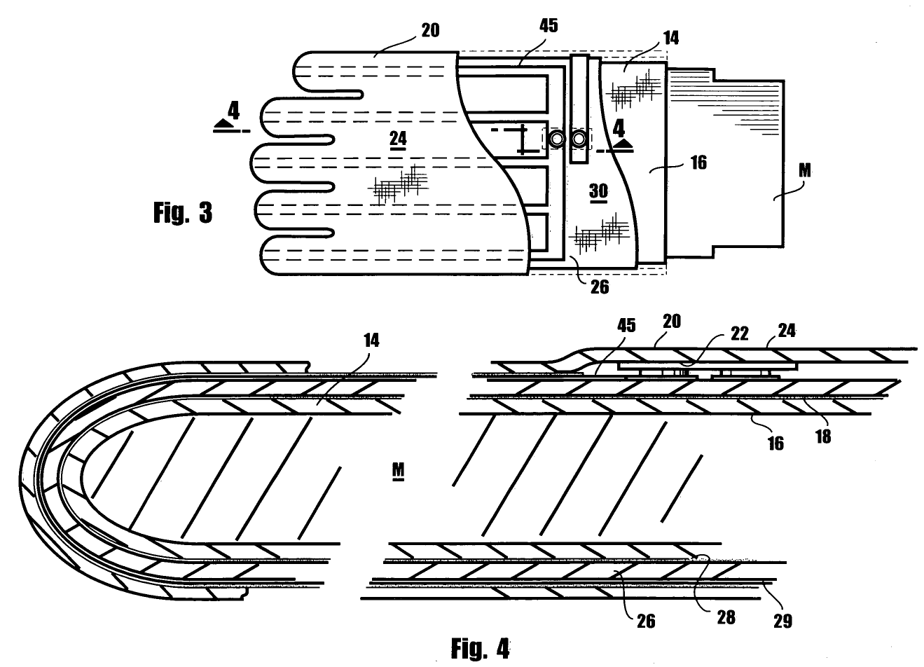

In FIGS. 3 and 4 the glove 12 is shown mounted on a relatively thin, generally hand-shaped aluminum mandrel “M”.

Glove portions 14, 20 and 26 can be constructed in various ways from a number of different types of materials, including fabrics made by knitting and weaving processes well understood by those skilled in the art. However, the glove portions of the present invention are preferably knit using a yarn sold by E. I. du Pont de Nemours and Company under the name and style NOMEX. For reasons presently to be described, the yarn preferably includes a spandex core. Spandex comprises a long-chain synthetic polymeric fiber. Soft and rubbery segments of polyester or polyether polyols allow the fiber to stretch up to 600% and then recover to its original shape. Hard segments, usually urethanes or urethane-ureas, provide rigidity and so impart tensile strength and limit plastic flow. The knitting of the glove components can be accomplished using various types of knitting machines, including machines made by Shima Seiki, Ltd., of Wakayama, Japan. It is to be understood that various types of natural, as well as man-made synthetic fibers can be used to construct the glove components of the invention.

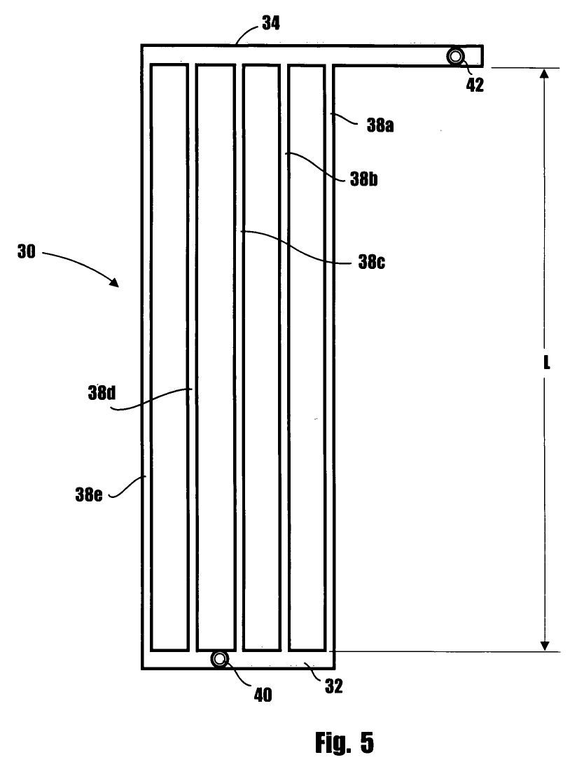

As illustrated in FIG. 5 of the drawings, the important heating harness 30 component of the invention here comprises an elongated, substantially flat positive bus 32 constructed from a flexible material and an elongated, substantially flat negative bus 34 also constructed from a flexible materia. Heating harness 30 also includes a plurality of elongated, substantially flat, stretchable tape-like connector members 38a, 38b, 38c, 38d and 38e of equal length that are interconnected with the first and second bus portions in a manner illustrated in FIG. 5. The stretchable connector members can be knit, spun, braided or woven, preferably from a nylon yarn of suitable weight, made from continuous filaments having approximately a 2% to 30% spandex component such as a nylon yarn made from continuous filaments having approximately a 2% to 30% spandex component.

The extremities of the elongated tape-like members 38a, 38b, 38c, 38d and 38e can be connected to the bus portions 32 and 34 in any suitable manner, such as by sewing or adhesive bonding. In the preferred form of the method of the invention, one end of each of the heater elements is stitched to the first bus 32 by ordinary sewing methods, using type 6.6 nylon threads. The opposite end of each heater element is then stitched to the other bus 34 in a similar manner. Uniquely, the heater elements are substantially equal in length in their relaxed state and are flexible so that they can be stretched and bent while still remaining essentially flat.

Following the interconnection of the extremities of the elongated tape-like members to the bus portions 32 and 34, the next step in the method of constructing the heating harness assembly is to form a precursor heating harness by connecting to the positive bus 32 an electrical connector 40 and by connecting to the negative bus 34 an electrical connector 42. Electrical connectors 40 and 42 are of conventional construction and function to enable the interconnection with the precursor heating harness of a controller assembly 44, the character of which will presently be described.

Following construction of the basic, precursor heating harness, the next step in the method of constructing the heating harness assembly, is to coat the precursor heating harness with the elemental silver to form a silver-coated heating harness. The harness plating step is preferably accomplished by a process commonly known as electroless plating. A company capable of accomplishing this silver plating step is Carolina Silver Technologies LLC of Valdese, N.C. Details concerning this electroless plating process can be obtained from this latter company. It is to be understood that, in certain instances, the tapes, ribbons, yarns, or filaments that make-up the components of the heater harness can be silver-plated prior to their inter-connection to form the heating harness.

As is well understood by those skilled in the art, when yarn or fabric that contains both nylon and spandex components is plated by electroless plating, only the nylon component is plated and the spandex component remains bare. This is because the plating activator only affects the nylon component and not the spandex component. The electroless silver plating process is typically performed at temperatures below 200° F. so as to not adversely affect the stretch quality of the spandex. Following the plating step, the silver-plated harness is electrically conductive, is flexible and durable. Additionally, experience has shown that the silver-plated harness, which can be powered by 6 V DC up to 30 watts, is quite suitable for use in the construction of the electrically heated gloves of the present invention.

The next step in the preferred form of the method of the invention is to coat the silver-plated harness with an electrically insulating material, such as an ultra-violet cured polyurethane elastomeric polymer to form an insulated harness 45. The coating process, which is of a character well understood by those skilled in the art, produces a coating that is waterproof, one which exhibits a shore hardness of approximately 40 A to 80 A and one that has a stretch quality at least 100% before rupture.

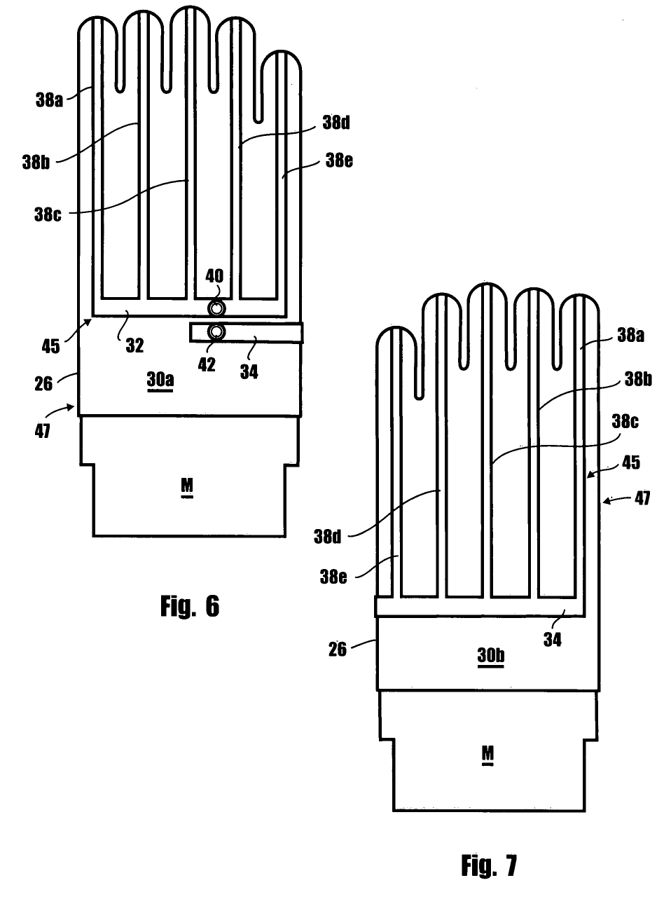

In carrying out the method of the invention for constructing the three-ply, insulated, electrically heated glove of the invention is to stretch the inner liner 14 over the previously mentioned sheet aluminum, generally planar mandrel “M” to form a first sub-assembly. This done, the liner 26 is stretched over the first sub-assembly and the insulated harness 45 is affixed to the liner 26 in the manner illustrated in FIGS. 6 and 7 of the drawings. The insulated harness is affixed to the inner-liner 26 by means of a temperature-activated, thermo-setting adhesive. More particularly, this adhesive bonding step is accomplished by first placing a suitable adhesive unto the inside, or lower face of the insulated heater harness 45 to form a coated insulated heating harness. One suitable adhesive for accomplishing this process is a powdered heat-activated adhesive made by Ems Chemie U.S.A. of Sumpter, S.C. In accomplishing the bonding step, the insulated harness is laid flat on a level surface with the inside face exposed. With the insulated harness in this position, the powdered adhesive is sprinkled onto the harness face and is then fused thereto in a manner well understood by those skilled in the art through the use of a radiant heater operating at a temperature sufficient to activate the adhesive. Next, the adhesive-covered, or coated, insulated harness is placed onto the exposed, or outer, surface of the liner component 26 with the powdered adhesive-coated side bearing against the knit glove and arranged as shown in FIGS. 6 and 7 of the drawings to form a second sub-assembly, or precursor glove assembly 47 having an outer surface. As depicted in FIG. 3, the buses 32 and 34 are located a precise distance from the fingertips of the glove and bus 34 is wrapped around the edge of the assemblage to bring the connection point to the back side of the wrist.

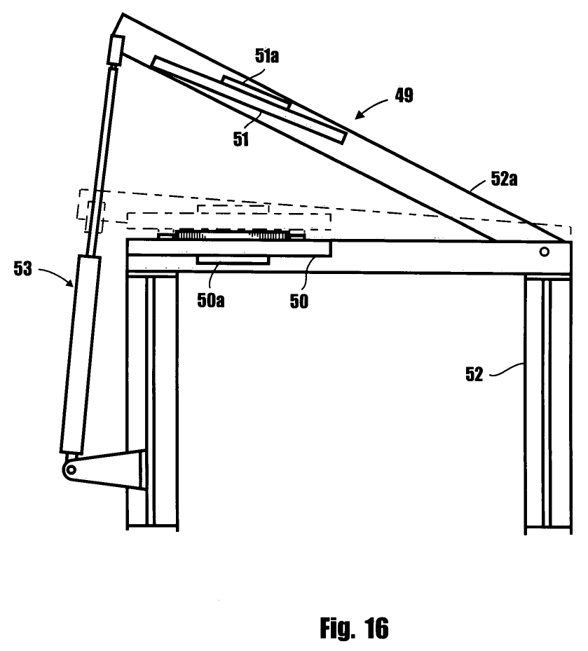

The precursor glove assembly 47 thus formed is then heated and compressed in an appropriate platen press 49, such as that shown in FIG. 16 of the drawings with both platens 50 and 51 being heated to a temperature of about 375° F. for several minutes.

As shown in FIG. 16, the platen press assembly here comprises a supporting frame 52 to which lower platen 50 is suitably affixed. Pivotally connected to frame 51 is a pivoting frame assembly 52a to which upper platen 51 is pivotally connected. At least one conventional air cylinder assembly 53 is connected to supporting frame 52 to controllably move the pivoting frame assembly 51a from the first open position shown by the solid lines in FIG. 16 to the second closed position shown by the phantom lines in FIG. 16. Platens 50 and 51 are controllably heated by means of conventional electric-resistance elements 50a and 52a which are mounted in intimate contact with the platens. Platens 50 and 52 are preferably massive pieces of aluminum which provide a heat sink. The temperature of each platen is continuously monitored by a suitable thermal controller of a character well known in the art (not shown) utilizing a thermocouple affixed to the platen (not shown).

This combination heating and compression step of the method of the invention activates the adhesive so as to securely and simultaneously bond the insulated heater harness 45 to both sides (that is, the back of hand side 30a and palm side 30b) of the liner component 26 simultaneously to form a cured precursor glove assembly (see FIGS. 6 and 7).

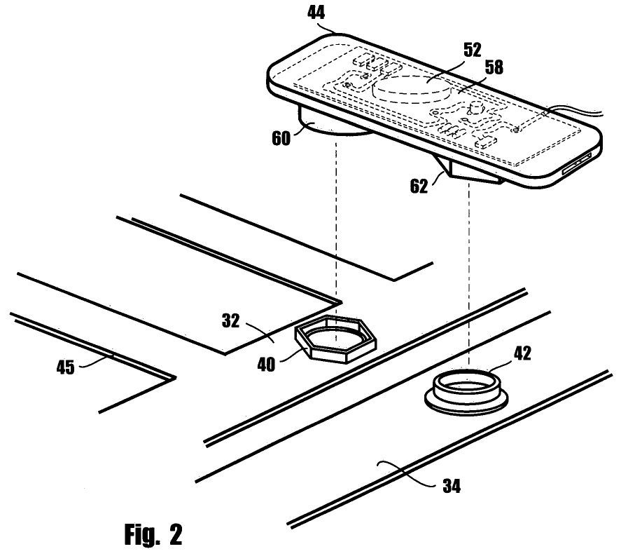

In practice, the negative bus 34 is constructed so that when it is in a relaxed condition its length will be slightly less than the dimension required to traverse from the wrist on the back of the hand to the wrist on the front of the hand. Accordingly, when is it is affixed to the inner-liner 26 in the manner shown in FIGS. 2 and 3 of the drawings it will be somewhat stretched. Similarly, the tapes 38a, 38b, 38c, 38d and 38e, which interconnect the positive and negative buses, will be constructed so that the length of each of the tapes in its relaxed state is approximately equal to the relaxed length “L” of the tape 38a (FIG. 5) that extends from the positive bus 32 over the thumb portion “T” of the glove (FIG. 1) and on to the negative bus 34. For example, the relaxed length of the tape 38a should be such that as the tape is extended from the bus 32 over the thumb portion and to the negative bus 34 it will be somewhat stretched. Similarly, the length of each of the remaining tapes is such that each tape may be stretched a different amount and will be slightly stretched as the tape extends from the positive bus 32 over a selected one of the finger portions of the glove and to the negative bus 34 in a manner shown in FIG. 1 of the drawings. With this unique construction, each of the stretched tapes, being of the same length in their relaxed state, will still exhibit the same electrical resistivity because the texturized, silver-plated conductive fibers that form the fingers, while straightened, have not been lengthened.

The next step in one form of the method of the invention for making an electrically heated two-ply glove is to coat the outer surface of the second sub-assembly, or cured precursor glove assembly with an adhesive to form an adhesive-coated cured precursor glove assembly, or coated second sub-assembly. This done, the adhesive is then fused to the outer surface in a manner well understood by those skilled in the art through the use of a radiant heater operating at a temperature sufficient to activate the adhesive. With the adhesive-coated, cured precursor glove assembly still in position over the mandrel “M”, the outer fabric portion 20 is placed over the adhesive-coated, cured second sub-assembly with the inner face 22 thereof in engagement with the adhesive-coated, cured second sub-assembly. The assemblage thus formed is then compressed in a manner to urge the outer fabric portion 20 into engagement with the adhesive-coated cured second sub-assembly to form a precursor article. This compression step is accomplished using the platen press shown in FIG. 16 of the drawings and is carried out in a manner similar to the method for making the cured precursor glove assembly. More particularly, with both platens 50 and 52 heated to a temperature of about 375° F., which is sufficient to bond said outer fabric portion 20 to the adhesive-coated cured second sub-assembly, the assemblage is placed under compression for several minutes. This step in the method of the invention activates the adhesive so as to securely and simultaneously bond together the adhesive-coated cured second sub-assembly and the outer fabric portion 20. With this construction, the insulated heater harness 45 is securely captured between the inner layer components 30 and the outer layer components 22 to appropriately form the two-ply precursor article of the invention.

The final step in the method for forming the two-ply electrically heated glove of the invention is to interconnect the controller assembly 44 with the electrical connectors 40 and 42 in a manner depicted in FIG. 2 of the drawings. In the present form of the invention the controller assembly 44 includes a battery 52 that is interconnected with a circuit board 58 that is, in turn, connected to electrical connectors 60 and 62 that mate with electrical connectors 40 and 42. When the electrical connectors are appropriately interconnected, electrical power can be supplied to the electrical harness to heat it to the desired elevated temperature as a result of the resistance caused by the elongated tape-like members of the electrical harness. The nature and size of the battery 56 depends largely on the end use to be made of the glove.

As illustrated in FIGS. 1 and 2, in one form of the invention the controller 44 can be interconnected via a conductor 60 and appropriate switching with an external source of electrical power “S” which may comprise a conventional DC power pack as, for example, a power pack carried about the waist of the user, or, alternatively, a source of alternating electrical current.

Considering next the method of the invention for constructing the three-ply electrically heated glove of the invention. This method is similar in many respects to the method of the invention for constructing the two-ply electrically heated glove and includes the steps of constructing the electrically heated harness and then bonding the harness to the inner-liner 26 in the manner previously described. However, in this latest method of the invention, after the electrically heated harness has been bonded to the inner-liner 26, the assemblage thus formed is removed from the mandrel “M” and the inner fabric covering 14 is placed over the mandrel. This done, the outer surface 18 of the inner covering 14 is coated with a heat-activated, thermo-setting adhesive of the same character used in performing the previously described method of the invention.

After the outer surface 18 of the inner covering 14 is coated with the adhesive, the adhesive is then fused to the outer surface in a manner well understood by those skilled in the art through the use of a radiant heater operating at a temperature sufficient to activate the adhesive. The assembly made up of the electrically heated harness and inner-liner 26 is then placed over the adhesive-coated inner covering 14 so that the inner surface 28 of the inner-liner 26 is in engagement with the adhesive-coated outer surface 18 of the inner covering to form a two-ply assemblage. The two-ply assemblage is then compressed in a manner to urge the inner surface 28 of the inner-liner into engagement with the outer surface of the inner fabric portion 14. This compression step is accomplished much in the same manner as previously described using the platen press shown in FIG. 16 of the drawings. More particularly, with both platens 50 and 52 heated to a temperature of about 375° F., which is sufficient to bond the inner-liner 26 to the adhesive-coated inner covering 14, the assemblage is placed under compression for several minutes. This step in the method of the invention activates the adhesive so as to securely and simultaneously bond together the adhesive-coated inner-liner 14 and the assemblage made up of the electrically heated harness in the inner-liner 26 cured second sub-assembly to thus form a cured two-ply sub-assembly.

Next, while the cured two-ply sub-assembly remains in position over the mandrel “M”, the exposed surface of the cured two-ply sub-assembly is coated with a heat-activated, thermo-setting adhesive to form a coated, cured two-ply sub-assembly. This done, the adhesive is then fused to the exposed surface in a manner well understood by those skilled in the art through the use of a radiant heater operating at a temperature sufficient to activate the adhesive. Next, the outer covering is placed over the coated, cured two-ply sub-assembly in the manner illustrated in FIGS. 3 and 4 to form a precursor electrically heated glove. With this construction, the insulated heater harness 45 is securely captured between the inner layer 26 and the outer layer component 20 to appropriately form the three-ply precursor article of the invention. The three-ply assemblage is then compressed in a manner to urge the inner surface 22 of the outer covering 20 into engagement with the outer surface 30. Once again, this compression step is accomplished much in the same manner as previously described using the platen press shown in FIG. 16 of the drawings. More particularly, with both platens 50 and 52 heated to a temperature of about 375° F., which is sufficient to bond the outer covering 20 to the adhesive-coated inner-liner 26, the assemblage is placed under compression for several minutes. This step in the method of the invention activates the adhesive so as to securely and simultaneously bond together the outer covering 20 to the adhesive-coated inner-liner 26 to thus form a cured three-ply sub-assembly.

The final step in the method for forming the three-ply electrically heated glove of the invention is to interconnect the controller assembly 44 with the electrical connectors 40 and 42. This can be accomplished by first folding back the cuff portion of the outer covering 20 so as to expose the electrical connectors 40 and 42 and then by interconnecting electrical connectors 60 and 62 to the exposed electrical connectors 40 and 42. When the electrical connectors are appropriately interconnected, electrical power can be supplied to the electrical harness to heat it to the desired elevated temperature as a result of the resistance caused by the elongated tape-like members of the electrical harness.

As previously mentioned, in an alternate form of the method of the invention, the buses 34 and 36 as well as the tapes 38a, 38b, 38c, 38d, and 38e can be silver-plated by the electroless plating process previously described prior to being assembled into the heating harness. In this alternate method of the invention, the plating of the assembled heating harness is not necessary. The plated precursor heating harness is then further processed in the same manner as the previously described silver-plated harness.

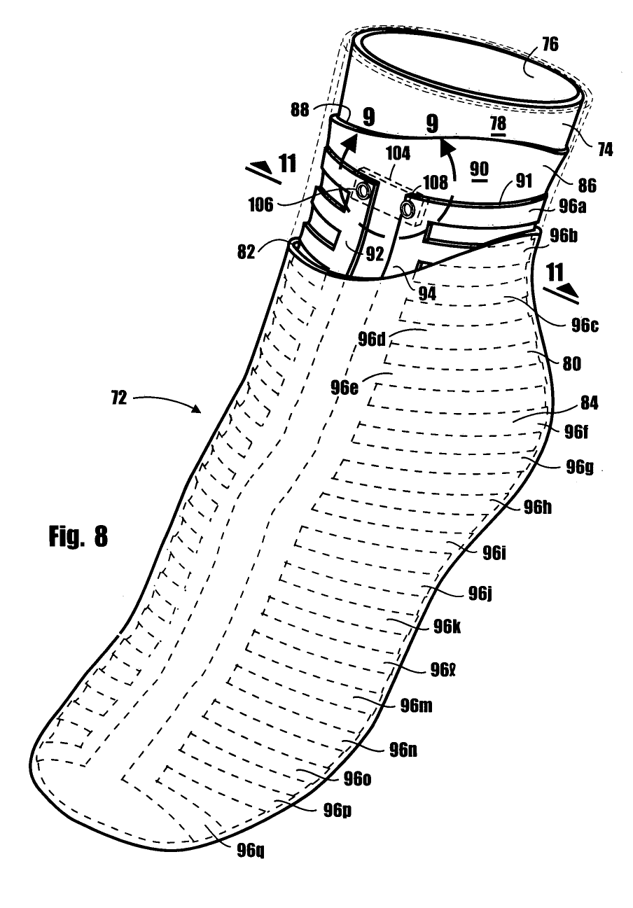

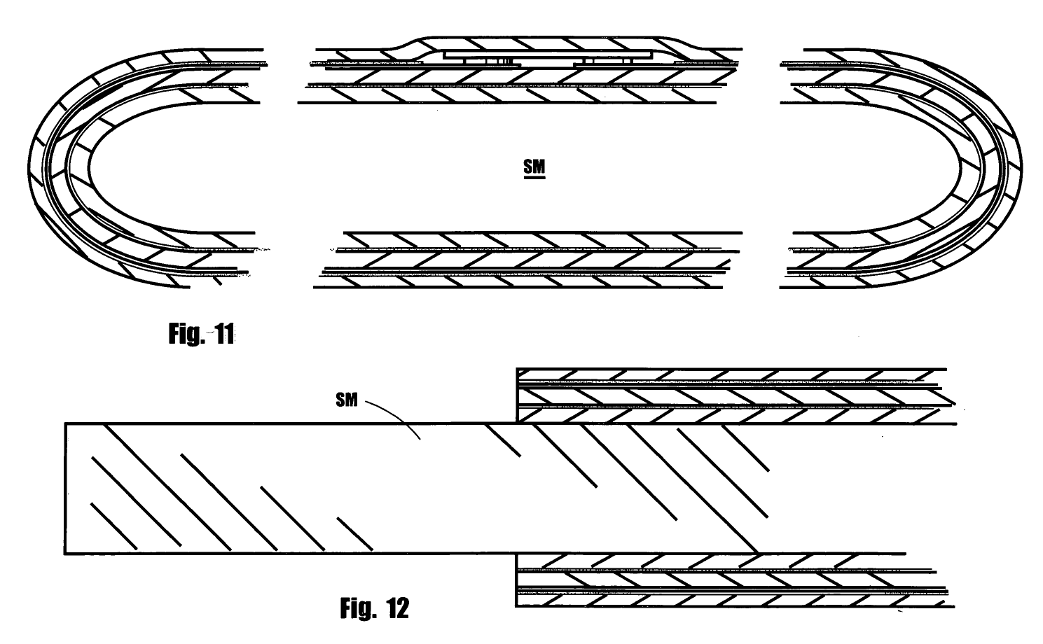

Referring now to FIGS. 8 through 15, an alternate form of electrically heated article of apparel of the present invention, here shown as a sock, is there illustrated and generally designated by the numeral 72. As best seen in FIGS. 8, 9 and 10, the electrically heated sock 72, like the previously described electrically heated glove, comprises a three-ply construction that includes a user contact, or inner sock portion 74 having inner and outer surfaces 76 and 78 and an outer sock portion 80 having inner and outer surfaces 82 and 84. Disposed intermediate portions 74 and 80 is a liner sock portion 86 having inner and outer surfaces 88 and 90.

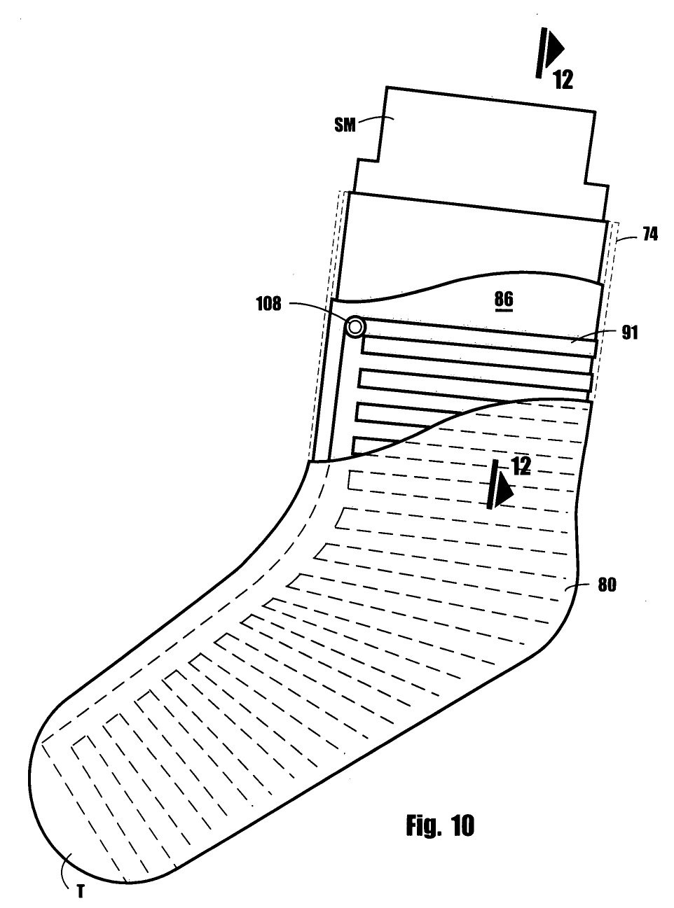

In FIGS. 10, 11 and 12 the sock is shown mounted on a relatively thin, generally foot shaped aluminum sock mandrel “SM” that is similar in construction to the previously described mandrel “M”.

Sock portions 74, 80 and 86 can be constructed in various ways from a number of different types of materials, including fabrics made by knitting and weaving processes well understood by those skilled in the art. However, the sock portions of the present invention are preferably knit using the previously described yarn sold by E. I. du Pont de Nemours and Company under the name and style NOMEX. The knitting of the sock components can be accomplished using various types of knitting machines, including machines made by Shima Seiki, Ltd., of Wakayama, Japan. It is to be understood that various types of natural, as well as man-made synthetic fibers can be used to construct the sock components of the invention.

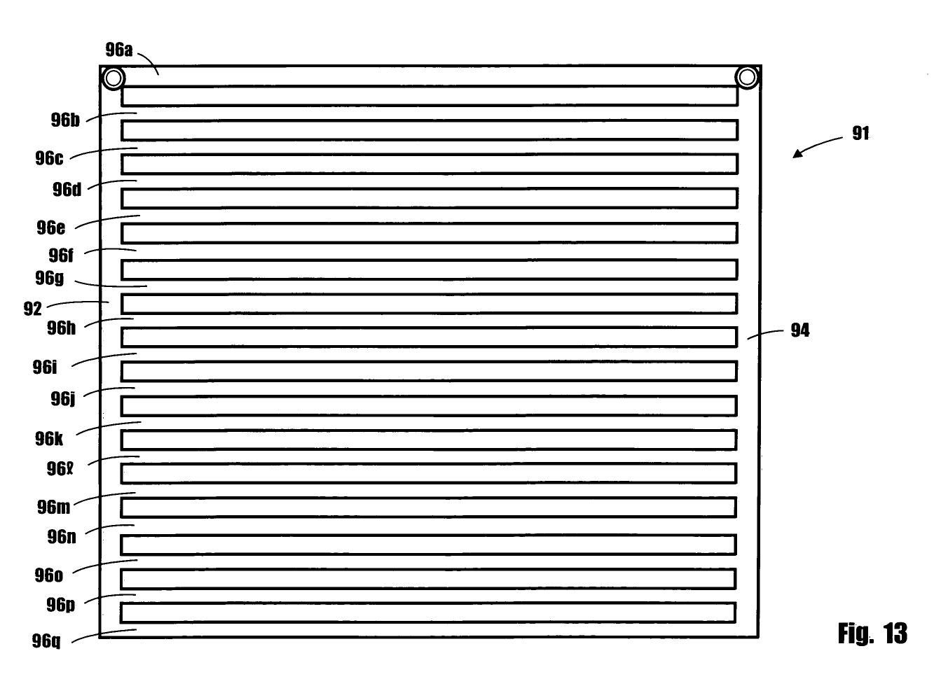

As illustrated in FIG. 13 of the drawings, the important heating harness 91 component of the invention here comprises an elongated, substantially flat positive bus 92 constructed from a stretchy and flexible material and an elongated, substantially flat negative bus 94 also constructed from a stretchy and flexible material. Heating harness 91 also includes a plurality of elongated, substantially flat, stretchable tape-like connector members 96a, 96b, 96c, 96d, 96e, 96f, 96g, 96h, 961, 96j, 96k, 96i, 96m, 96n, 960, 96p and 96q of equal length that are interconnected with the first and second bus portions in a manner illustrated in FIG. 13. The stretchable connector members can be knit, spun, braided, or, woven preferably from a Type 6.6 nylon yarn of suitable weight, made from continuous filaments having approximately a 2% to 30% spandex component such as a nylon yarn made from continuous filaments having approximately a 2% to 30% spandex component.

The extremities of the elongated tape-like members can be connected to the bus portions 92 and 94 in any suitable manner, such as by sewing or adhesive bonding. In the preferred form of the method of the invention, one end of each of the beater elements is stitched to the first bus 92 by ordinary sewing methods, using type 6.6 nylon threads. The opposite end of each heater element is then stitched to the other bus 94 in a similar manner. As in the earlier described embodiment of the invention, the heater elements are substantially equal in length in their relaxed state and are flexible so that they can be stretched and bent while still remaining essentially flat.

Following the assembly of the heating harness in a manner shown in FIG. 13 of the drawings, the heater elements as well as the positive and negative bus portions are plated with elemental silver to form a silver-plated sock harness. As before, the harness plating step is preferably accomplished by a process commonly know as electroless plating. Experience has shown that the silver-plated harness, which can be powered by 6 V DC up to 30 watts, is quite suitable for use in the construction of the electrically heated socks of the present invention.

The next step in this latest form of the method of the invention is to coat the silver-plated sock harness in the manner previously described with an electrically insulating material, such as a ultra-violet cured polyurethane elastomeric polymer to form an insulated harness.

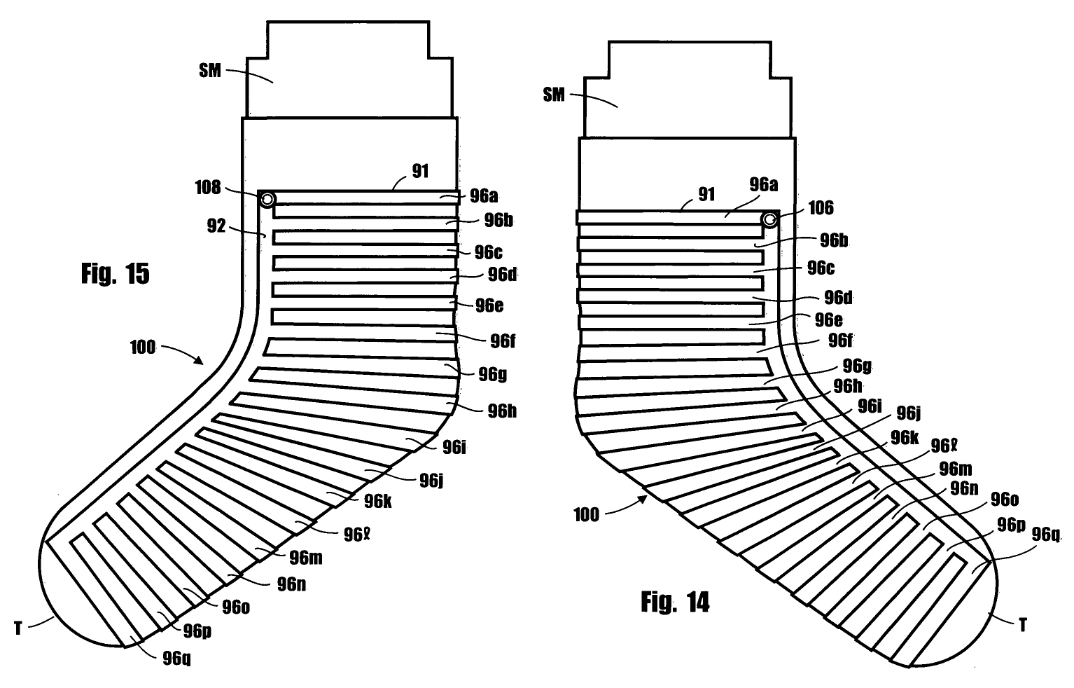

In carrying out this latest method of the invention, the next step is to affix, by means of a temperature-activated adhesive, the insulated harness to the liner sock portion 86, that has been stretched over the previously mentioned sheet aluminum mandrel “SM”. This adhesive bonding step is accomplished by first placing a suitable adhesive, such as a powdered heat-activated adhesive made by Ems Chemie U.S.A. of Sumpter, S.C., onto the inside, or lower, face of the heater harness 91. In accomplishing the bonding step, the insulated harness is laid flat on a level surface with the inside face exposed. With the insulated harness in this position, the powdered adhesive is sprinkled onto the harness face and is then fused thereto in a manner well understood by those skilled in the art through the use of a radiant heater operating at a temperature sufficient to activate the adhesive. Next, the adhesive-covered, insulated harness is placed unto the exposed surface of the liner sock portion 86 with the powdered adhesive-coated side bearing against the knit sock and arranged as shown in FIGS. 14 and 15 of the drawings. The precursor assembly 100 thus formed is then heated in an appropriate platen press, such as that shown in FIG. 16 of the drawings with both platens heated to a temperature of about 375° F. for several minutes. This step in the method of the invention activates the adhesive so as to securely and simultaneously bond the insulated sock heater harness to both sides of the liner sock portion 86.

In practice, the buses 92 and 94 are constructed so that when in a relaxed condition their length will be slightly less than the dimension required to circumscribe the mandrel in the manner depicted in FIGS. 14 and 15. Accordingly, when it is affixed to the liner sock portion 86 in the manner shown in FIG. 8 of the drawings they will be somewhat stretched. Similarly, the tapes, which interconnect the positive and negative buses, will be constructed so that the length of each of the tapes in its relaxed state is approximately equal to the relaxed length “L” of the tape 96q that circumscribes the toe portion “T” of the mandrel “SM” in the manner depicted in FIG. 15. Preferably, the relaxed length of the tape 96q should be such that as the tape is extended from the bus 92 over the toe of the mandrel to the negative bus 94 it will be somewhat stretched. Similarly, the length of each of the remaining tapes is such that each tape will be stretched as the tape extends from the positive bus 92 over a selected one of the portions of the sock and to the negative bus 94 in a manner shown in FIG. 8 of the drawings. With this unique construction, each of the stretched tapes, being of the same length in their relaxed state, will still exhibit the same electrical resistivity because the texturized, silver-plated conductive fibers that form the tapes, while straightened, have not been lengthened.

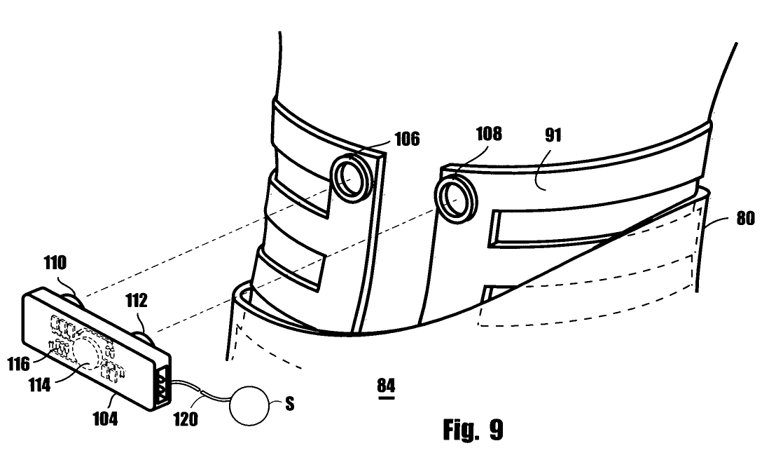

The final step in the method for forming the three-ply electrically heated sock of the invention is to interconnect the controller assembly 104 with the electrical connectors 106 and 108 (FIGS. 8 and 9), which are of similar construction and operation to the previously described controller assembly 44 and the electrical connectors 40 and 42. This can be accomplished by first folding back the cuff portion of the outer covering 80 so as to expose the electrical connectors 106 and 108 and then by interconnecting electrical connectors 110 and 112 to the exposed electrical connectors 106 and 108. As before, when the electrical connectors are appropriately interconnected, electrical power can be supplied from the battery 114 via the circuit 116 of the controller to the electrical harness to heat it to the desired elevated temperature as a result of the resistance caused by the elongated tape-like members of the electrical harness.

As illustrated in FIG. 9, in one form of the invention the controller 104 can be interconnected via a conductor 120 and appropriate switching with an external source of electrical power “S” which may comprise a conventional DC power pack, or alternatively a source of alternating electrical current.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A method of making an electrical heating harness for use in heating articles of apparel, said method comprising the steps of:
(a) constructing an elongated negative bus from a flexible material;
(b) constructing an elongated positive bus from a flexible material;
(c) constructing a plurality of elongated connector members from a stretchable material, each said connector members being of equal length and having a first extremity and a second extremity;
(d) connecting said first extremity of each of said connector members to said negative bus;
(e) connecting said second extremity of each of said connector members to said positive bus to form a heating harness assembly;
(f) connecting to said heating harness assembly to form a precursor heating harness, a connector element for interconnection therewith of a controller assembly, that includes a source of electrical energy; and
(g) plating said precursor heating harness with silver to form a silver-coated heating harness.

2. The method as defined in claim 1, including a further step of coating said silver-coated heating harness with an insulation to form an insulated heating harness.

3. The method as defined in claim 2 including a further step of connecting said controller assembly to said connector of said silver-coated heating harness.

4. The method as defined in claim 2 in which each of said plurality of elongated connector members is formed from a stretchable fabric.

5. The method as defined in claim 2 in which each of said plurality of elongated, substantially flat connector members is formed from a stretchable fabric comprising a knit fabric formed from a nylon yarn having a spandex component.

6. The method as defined in claim 2 in which said insulation comprises an electrical insulation.

7. The method as defined in claim 2 in which said insulation comprises an electrical and waterproofing insulation.

8. A method of making an electrically heated article of apparel comprising a fabric liner portion having an inner surface and an outer surface, said method comprising the steps of:
(a) constructing a flexible heating harness comprising a positive bus, a spaced-apart negative bus and a plurality of the elongated, stretchable members connected to and spanning said positive and negative buses;
(b) plating said flexible heating harness with silver to form a silver-coated heating harness;
(c) interconnecting said silver-coated heating harness with the fabric liner portion to form a first sub-assembly; and
(d) interconnecting said silver-coated heating harness of said first sub-assembly with a source of electrical power.

9. The method as defined in claim 8 in which said flexible heating harness further comprises a connector element for interconnection therewith of a controller assembly that includes a source of electrical energy.

10. The method as defined in claim 8, including the further step prior to interconnecting said silver-coated harness with said fabric liner portion, coating said silver-coated heating harness with an insulating material.

11. The method as defined in claim 8 in which the electrically heated article of apparel further comprises a fabric inner portion and in which said method includes the further step of interconnecting said first sub-assembly with the fabric inner-liner portion to form a first sub-assembly.

12. The method as defined in claim 11 in which the electrically heated article of apparel further comprises a fabric outer portion and in which said method includes a further step of interconnecting the fabric outer portion with said first sub-assembly.

13. The method as defined in claim 12 in which the electrically heated article of apparel comprises a glove.

14. The method as defined in claim 12 in which the electrically heated article of apparel comprises a sock.

15. A method of making an electrically heated article of apparel constructed of a positive bus, a negative bus, a plurality of elongated stretchable members, an outer fabric portion having an inner face and an outer face and a liner portion having an inner surface and an outer surface, said method comprising the steps of:
(a) silver plating the positive bus, the negative bus and the plurality of elongated stretchable members to form a plated positive bus, a plated negative bus and a plurality of plated elongated stretchable members;
(b) constructing a plated flexible heating harness assembly comprising a plated positive bus, a spaced-apart plated negative bus and a plurality of plated elongated, stretchable members connected to and spanning said plated positive and negative buses;
(c) connecting to said plated flexible heating harness assembly to form a precursor heating harness, a connector element for interconnection therewith of a controller assembly, that includes a source of electrical energy;
(d) coating said precursor heating harness with an insulation to form an insulated heating harness;
(e) placing the liner portion over a planar mandrel with said first face thereof being located adjacent said mandrel to form a first sub-assembly;
(f) coating said insulated heating harness with an adhesive to form a coated, insulated heating harness;
(g) placing said coated, insulated heating harness over said first sub-assembly to form a second sub-assembly having an outer surface;
(h) coating said outer surface of said second sub-assembly with an adhesive to form a coated second sub-assembly;
(i) placing the outer fabric portion over said coated second sub-assembly with said inner face thereof in engagement with said coated second sub-assembly; and
(j) compressing said coated second sub-assembly to urge said outer fabric portion into engagement with said coated second sub-assembly to form a precursor article.

16. The method as defined in claim 15 in which said adhesive is thermo-setting and in which said method includes the further step of heating said precursor article during the compressing step to a temperature sufficient to bond said outer fabric portion to said coated second sub-assembly.

17. The method as defined in claim 16 including the further step of interconnecting said controller assembly with said connector element of said precursor heating harness.

18. A method of making an electrically heated article of apparel constructed of an inner fabric portion having an interface and an outer face, an outer fabric portion having an inner face and an outer face and an intermediate liner portion having an inner surface and an outer surface, said method comprising the steps of:
(a) constructing a flexible heating harness assembly comprising a positive bus, a spaced-apart negative bus and a plurality of elongated, stretchable members connected to and spanning said positive and negative buses;
(b) connecting to said flexible heating harness assembly to form a precursor heating harness, a connector element for interconnection therewith of a controller assembly, that includes a source of electrical energy;
(c) plating said precursor heating harness with silver to form a silver-coated heating harness;
(d) coating said silver-coated heating harness with an insulation to form an insulated heating harness;
(e) placing the intermediate liner portion over a planar mandrel with said first face thereof being located adjacent said mandrel to form a first sub-assembly;
(f) coating said insulated heating harness with an adhesive to form a coated insulated heating harness;
(g) placing said coated insulated heating harness over said first sub-assembly to form a second sub-assembly having an outer surface;
(h) coating said outer surface of said second sub-assembly with an adhesive to form a coated second sub-assembly;
(i) placing said outer fabric portion over said coated second sub-assembly with said inner face thereof in engagement with said coated second sub-assembly; and
(j) compressing said coated second sub-assembly to urge said outer fabric portion into engagement with said coated second sub-assembly to form a precursor article.

18. The method as defined in claim 17 in which said adhesive is thermo-setting and in which said method includes the further step of heating said precursor article during the compressing step to a temperature sufficient to bond said outer fabric portion to said coated second sub-assembly.

19. The method as defined in claim 17 in which said heating harness is coated with elemental silver by an electroless process.

20. The method as defined in claim 17 in which said insulation comprises an ultra-violet cured polyurethane elastomeric polymer.
